(19) United States
(12) Patent Application Publication
(10) Pub. No.: US 2001/0021242 A1
(43) Pub. Date: Sep. 13, 2001

(54) Method and device for the focussing of X-rays for the realization of X-ray - zoom - optics

(75) Inventors: Aniouar Bjeoumikhov, Berlin (DE); Johannes Rabe, Berlin (DE); Norbert De Langhoff, Berlin (DE)

Correspondence Address: HEROLD AND HAINES, P.A., 25 Independence Boulevard, Warren, NJ, 07059, US

(73) Assignee: IFG Institut fur Geratebau GmbH

(21) Appl. No.: 09/800,804

(22) Filed: Mar. 7, 2001

(30) Foreign Application Priority Data
Mar. 7, 2000 (DE) 100 11 882.8

(51) Int. Cl. G21K 1/06

(52) U.S. Cl. 378/84; 378/85; 378/145

(57) ABSTRACT

The invention describes a method and a device for the focussing of X-rays by means of glass capillary optics and serves, in particular, the purpose of realization of X-ray-zoom-optics. The method is based on the fact that, by means of the alteration of the distances of two semi-lenses arranged opposite each other, the focal lengths can be adjustably set.

The design of the device is selected in such a way that the distance between the two semi-lenses can be set by means of a highly-sensitive rotary mechanism. In this way, for example, focal lengths ranging between 50 and 300 mm can be adjustably set.

### DESCRIPTION

The invention concerns a method and a device for the focussing of X-rays by means of glass capillary optics and serves in particular the purpose of realization of X-ray-zoom-optics.

The purpose of X-ray optics is to focus, make parallel and/or to monochromatize the generally diverging X-rays of an X-ray source. Due to the considerably higher photons energy as compared with visual light, the known optics, as known from visual light to VUV, cannot be used. Where the optics according to the invention are concerned, glass capillary systems are adopted where the physical effect of the total reflection of photons on smooth solid body surfaces is applied. The literature contains descriptions of various incipient solutions and glass capillary optics, such as cylindrical monocapillaries as collimators, elliptical and parabolic monocapillaries for the generation of a parallel beam or for the purposes of focussing and finally the application and polycapillary systems with which a focus can be imaged on a focus, or a parallel beam is generated from a focus, or a parallel beam is to be focussed on a pre-specified point.

### BACKGROUND OF THE INVENTION

In the publications U.S. Pat. No. 5,497,008, WO 89/12817, EP 0555 376 B1, DE 44 08 057 and WO 95/24638 the use of capillary optical systems in the fields of X-ray diffractometry and the X-ray fluorescence analysis are described. Corresponding details pertaining to these applications fields can also be found in the publications M. A. Kumakhov, F. F. Komarov, Phys. Rep. Vol. 191, 289-350, 1990 as well as R. Wedell, “Röntgenlichtleiter in der Analysetechnik” (X-ray photoconductors in the analysis technique), Phys. Sheets 52, No. 11, 1134-1136.

The polycapillary optics according to the known state of the art indicate in this respect a pre-specified geometry which is determined by the distance of the two foci, by the photon energy range and by the equipment-technical pre-specified application conditions.

### DESCRIPTION OF THE RELATED ART

The invention is based on the task assignment of creating a method and a device with which the focal length of X-ray optics can be varied and X-ray-zoom-optics can be realized with nonsophisticated means. This task assignment is solved according to the invention by the features in the claims 1 and 4. Purposeful embodiments of the invention are described in the Subclaims.

A particular advantage of the invention is the possibility of realizing a steplessly adjustable variation of the distance of the foci, where the X-ray light emitted with the help of a point source is captured in a relatively large solid angle and is bundled to a parallel beam. This parallel beam enters a second polycapillary semi-lens which focuses this on a point with the required distance. In order to reduce the radiation losses between both semi-lenses, a cylindrical monocapillary can be used.

For further beam manipulation, the following items can be integrated in the housing in which the semi-lenses and the monocapillaries are located:

crystals for the monochromatization of the beam

filters as absorbers for the suppression of the long-wave beam constituents and the Kβ-lines

detectors for the monitoring of the X-ray beam and

shutters for the attenuation of the beam as a protective measure.

The design of the device is selected in such a way that the distance between the two semi-lenses can be adjusted and set by means of a highly sensitive rotary mechanism. In this way, focal lengths ranging from 50 to 300 mm can be adjustably set. Where conventional solutions are concerned, hole collimators are used, with which beam diameters of up to 10 μm can be realized.

Further elements with the following functions can be attached to the beam outlet end of the housing:

detector assembly group with pre-amplifier which has a solid geometry for the analysis of the primary beam (inclination determines the distance between outlet of the optical unit and the specimen surface)

two optical point sources, such as lasers with whose help the exact distance between the excitation and measurement arrangement to the specimen surface can be adjustably set

a CCD-camera with an optical unit which allows the visual observation of the specimen surface.

In this way, a compact micro-RFA-equipment can be built up accordingly. It is also perceivable to place a conical polycapillary lens before the detector in order to improve the lateral resolution on the specimen surface.

In the event of application of the X-ray zoom optical system as described, an intensity gain with the factor of 100 and more can be realized. The result is that, depending on the application in various methods, either the measuring time can be reduced or work can be accomplished with low-output X-ray sources. This type of X-ray optical systems is used in the X-ray flourescence spectroscopy and X-ray diffractometry.

### BRIEF DESCRIPTION OF THE DRAWINGS

The equipment-technical realization of the invention will be better understood from the following description of a most preferred embodiment.

FIG. 1 shows a device designed as an adjustable capillary holder for two semi-lenses 2, 3 and a cylindrical capillary 4 which are arranged in a multi-part design housing 6.

Where this embodiment is concerned, two adjusting ranges 1a, 1b are realized which allow, by way of a rotary mechanism such as a precision thread, an increase or a decrease of the distance of the two semi-lenses 2 and 3 to each other and, subsequently, the distance of their foci.

In the embodiment presented here, a cylindrical monocapillary 4 is arranged between the two semi-lenses 2 and 3.

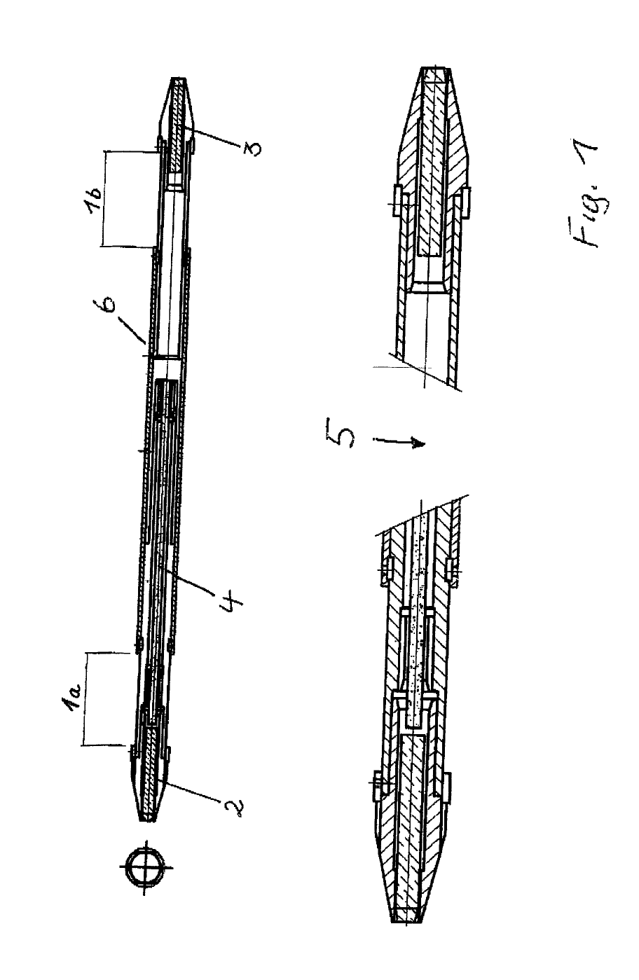

For the purpose of further beam manipulation, the stylized illustrated structural elements 5 of FIG. 1 can be integrated in the housing 6. These can be:

crystals for the monochromatization of the beam

filters as absorbers for the suppression of the long-wave beam constituents and the Kβ-lines

detectors for the monitoring of the X-ray beam and

shutters for the attenuation of the beam as a protective measure.

Further elements with the following functions can be attached to the beam outlet end:

detector assembly group with pre-amplifier which has a solid geometry for the analysis of the primary beam (inclination determines the distance between outlet of the optical unit and the specimen surface)

two optical point sources, such as lasers with whose help the exact distance between the excitation and measurement arrangement to the specimen surface can be adjustably set

a CCD-camera with an optical unit which allows the visual observation of the specimen surface.

The invention is not restricted to the embodiments as described here. Moreover, it is possible to realize further embodiment variants by means of an appropriate and suitable combination of the means and features already mentioned here, without going beyond the framework of the invention itself.

1. Method for the focussing of X-rays for the realization of an X-ray-zoom optical system, wherein,
by means of the alteration of the distances of two oppositely arranged semi-lenses, the focal lengths can be adjustably set.

2. Method according to claim 1 wherein
the X-ray light emitted with the help of a point source is captured in a relatively large solid angle and is bundled to a parallel beam, and this parallel beam enters a second polycapillary semi-lens which focuses this on a point with the required distance.

3. Method according to claim 1 wherein
a cylindrical monocapillary is used for the purpose of reduction of radiation losses between the two semi-lenses.

4. Device for focussing of X-rays for the realization of an X-ray-zoom optical system wherein,
in a housing (6), at least two semi-lenses (2, 3) opposite each other are adjustably arranged to each other with regard to their distance.

5. Device according to claim 4, wherein
a capillary (4) is arranged between the semi-lenses (2, 3).

6. Device according to claim 5, wherein
the capillary (4) is a cylindrical monocapillary.

7. Device according to claim 4, wherein,
for the purpose of further beam manipulation, further structural elements (5) are integrated in the housing (6).

8. Device according to claim 7, wherein
the structural elements (5) are crystals for the monochromatization of the beam and/or filters as absorbers for the suppression of the long-wave beam constituents and the Kβ-lines and/or detectors for the monitoring of the X-rays and/or shutters for the attenuation of the beam.

9. Device according to claim 4, wherein
further elements with the following functions are attached to the beam outlet end of the housing:
detector assembly group with pre-amplifier which has a solid geometry for the analysis of the primary beam (inclination determines the distance between outlet of the optical unit and the specimen surface)
two optical point sources, such as lasers with whose help the exact distance between the excitation and measurement arrangement to the specimen surface can be adjustably set
a CCD-camera with an optical unit which allows the visual observation of the specimen surface.

10. Device according to claim 4, wherein
the housing (6) has a multi-part design and the alteration of the distances of the semi-lenses (1a, 1b) is performed by means of a rotary mechanism.

11. Device according to claim 10, wherein,
the rotary mechanism interacts with high-precision threads.
